(19) United States
(12) Patent Application Publication
(10) Pub. No.: US 2003/0011819 A1
(43) Pub. Date: Jan. 16, 2003

(54) Information processing device, information processing method, printing system, computer program and memory medium

(75) Inventor: Masanari Toda, Kanagawa (JP)

Correspondence Address: HOGAN & HARTSON L.L.P., 500 S. GRAND AVENUE, SUITE 1900, LOS ANGELES, CA, 90071-2611, US

(73) Assignee: CANON KABUSHIKI KAISHA

(21) Appl. No.: 10/194,591

(22) Filed: Jul. 11, 2002

(30) Foreign Application Priority Data
Jul. 12, 2001 (JP) 2001-212673

(51) Int. Cl. B41J 1/00; G06F 15/00

(52) U.S. Cl. 358/1.15

(57) ABSTRACT

An information processing apparatus is connected to a printer that is capable of printing an image represented by image data whether the image data is received from the information processing apparatus in compressed format or non-compressed format. When a compressed image data is to be printed, the information processing apparatus estimates a processing time required for a process in which a non-compressed print image is generated at the information processing apparatus side, and a process time required for a process in which a non-compressed print image is generated at the printer side. A printing process for the compressed image data is conducted either at the information processing apparatus side or the printer side depending on the result of estimated processing times.

### BACKGROUND OF THE INVENTION

1. Field of the Invention

The present invention relates to an information processing device, its control method and printing system, as well as to a computer program and a memory medium.

2. Description of Related Art

First, a typical printing control method and a flow of processing in conventional printing systems will be described.

A general-purpose information processing device (hereinafter called a “host computer”), such as a personal computer, and a printer are generally connected to each other through a parallel interface with the specifications of a U.S. company, Centronics, a serial interface such as RS-232C, a network interface, or a USB (Universal Serial Bus) interface.

On the host computer side, an application software such as a word processor and a spreadsheet (hereinafter called “applications”) operate on so-called basic software (OS: operating system), such as Windows (trademark of Microsoft; this notation omitted hereafter).

When printing through an application, functions of a graphics subsystem are used from among a plurality of subsystems provided by the basic software through any program of the application. The graphics subsystem is called a Graphic Device Interface (GDI) in Windows, for example, and it governs the processing of image information to a display or printer.

The GDI dynamically links modules called device drivers in order to absorb the dependency of devices, such as displays and printers, and performs output processing to each of the devices. The module for a printer is called a printer driver. The printer driver must have a group of functions called DDI (Device Driver Interface), which is to be installed on the device driver in advance depending on its capacity and/or function. The GDI converts Application Programming Interface (API) calls from the application into data for the device driver, and the group of DDI functions is called by the GDI as necessary, so that a predetermined printing processing can be executed. In this way, the GDI processes in a sequential manner print demands from the application via the printer driver.

The processing system of the printer driver can be divided into two types: Printer Description Language (PDL) type and image type.

The PDL type is a processing system in which a controller that can process control commands called PDL is installed on the printer side, and its primary processing involves converting draw commands that are handed from the system via DDI functions into PDL commands.

On the other hand, in the image type processing system, high-level draw processing does not take place on the printer side. Instead, draw commands received through DDI functions are developed into print images by the printer driver, and image data thereby generated are sent to the printer to be printed.

As described above, in both the PDL mode and the image mode, draw commands are given via DDI functions from the system and the draw processing is executed.

The DDI functions can be divided into three major categories: characters, graphics and images. Here, we will describe the image draw functions in the Microsoft Windows system. At the time of initialization of a printer driver, the operating system inquires the drawing capacity of the printer driver. The DDI functions that are called vary depending on the response. For example, if the response is that the system is capable of enlargement and reduction processing in the image draw processing, a source image is sent from the application without any alterations. If the response is that a source image cannot be received, a source image is converted to a 1:1 magnified image data and such image data is sent from the application.

In Windows 95/98/Me, before functions for image processing are called, applications use Escape functions of Win32 API to check whether an image data that has been JPEG-compressed can be processed. If the printer driver responds that it can, the JPEG image is handed to the DDI function.

Using FIG. 3, a description is made as to a processing method that takes place when a source image is a JPEG image data. FIG. 3 shows image data 301 that has been JPEG-compressed. To print image data 302 that is pasted with a source image resolution on an application that can handle JPEG data, the printing system can use either of the following two methods:

1) When there is no JPEG decompression function provided in the printer:

The printer driver declares to the operating system that it cannot receive JPEG data. The JPEG-compressed image is decompressed and handed in a RGB24BPP format to the DDI (303). The printer driver attaches a print command to the image handed and sends them to the printer (304).

2) When there is a JPEG decompression function provided in the printer:

When the printer driver declares that it can receive JPEG data, the JPEG-compressed image is sent without any alterations to the DDI (305). The printer driver attaches a print command to the JPEG image and sends them to the printer (306). Inside the printer, the JPEG image data 306 received is decompressed and a process for generating and drawing an image 307 to be printed is performed.

In recent years, image data to be handled on PCs (host computers in this case) have been developed into a higher gray scale and higher resolution level, so that image data having a data size of dozens of megabytes or hundreds of megabytes in uncompressed format are not uncommon. At the same time, the performance of host computers and printers has also significantly improved. On the other hand, however, there are numerous legacy ports in transfer routes between host computers and printers, which can create problems in terms of transfer rates. This means that when the transfer rate required is several hundred kilobytes/second, sending the image data at a high compression rate allows the overall processing to be handled more quickly.

However, there are problems with this method. FIG. 4 shows a high compression JPEG image data 400 that is similar to the JPEG image data 301. When this data is reduced on an application and pasted onto a document, the following problems occur due to the fact that the JPEG-compressed image is handed to the DDI without any alterations, as before:

A) When there is no JPEG decompression function provided in the printer:

The printer driver declares that it cannot receive JPEG data. The JPEG-compressed image is decompressed and handed in a RGB24BPP format to the DDI (403). The printer driver attaches a print command to the image data that has been rendered a reduction processing as designated, and sends them to the printer (404).

B) When there is JPEG decompression function provided in the printer:

When the printer driver declares that it can receive JPEG data, the JPEG-compressed image that has been designated for reduction is sent to the DDI without any alterations (406). The printer driver sends to the printer the JPEG image with a print command designating reduction attached thereto (407). Inside the printer, the JPEG image data is rendered a draw processing after it is decompressed and reduced.

When the reduction rate is great, the data size sometimes becomes smaller when the data in JPEG-compressed format is decompressed and reduced before being sent rather than being sent in JPEG-compressed format. In other words, there is ample possibility that the system that declares for a high-speed data transfer that it has “JPEG decompression function” may turn out to be slower.

Some other conditions under which the same phenomenon can occur when “fine clipping overlaps a part of the drawing region,” “black and white output is requested,” and “binarization processing is conducted by the host computer”; these can be causes in which the data size is reduced.

### SUMMARY OF THE INVENTION

The present invention is provided in view of the problems described above, and more particularly to allow printing with the optimal throughput when a compressed image data stored in a host computer is transferred to a printer for printing.

In accordance with a preferred embodiment of the present invention, an information processing apparatus is connected to a printer that is capable of printing an image represented by image data whether the image data is received in compressed format or non-compressed format. The information processing apparatus includes a first print command generation device that generates a print command while compressed image data remains compressed, a second print command generation device that generates a print command when compressed image data is decompressed, an estimation device that estimates a processing time required for a printing process that uses the first print command generation device and a processing time required for a printing process that uses the second print command generation device when the image data for an image to be printed is compressed image data, and a selection device that selects one of the first print command generation device and the second print command generation device depending on an estimation result, wherein a printing process for the compressed image data is conducted with a print command that is generated by the selected one of the first print command generation device and the second print command generation device.

Other purposes and characteristics of the present invention shall become apparent from the following embodiments and drawings.

### BRIEF DESCRIPTION OF THE DRAWINGS

FIG. 1 shows a cross-sectional view of a laser beam color printer according to an embodiment.

FIG. 2 shows a diagram illustrating a functional structure of a printing system in accordance with an embodiment of the present invention.

FIG. 3 shows a diagram showing a normal flow of print data for a JPEG image.

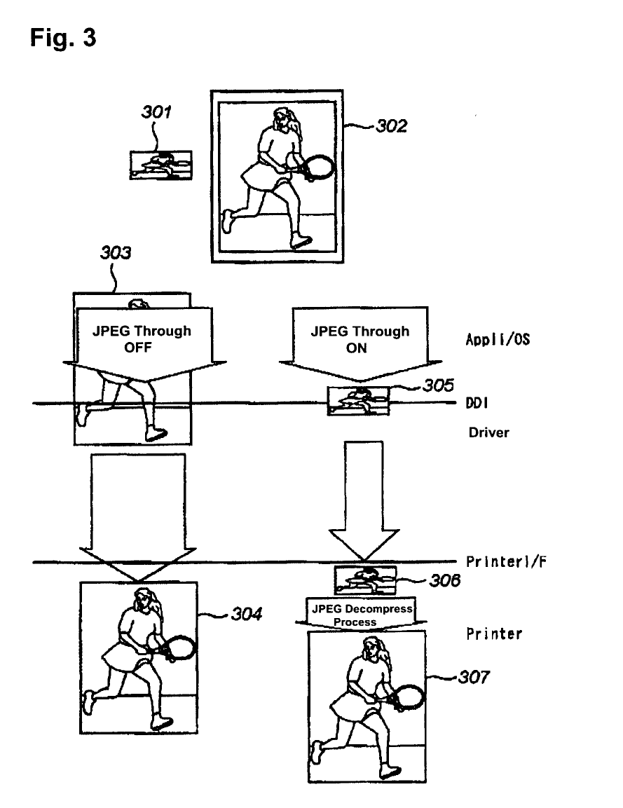

FIG. 4 is a drawing illustrating the problems in a conventional method of processing JPEG images.

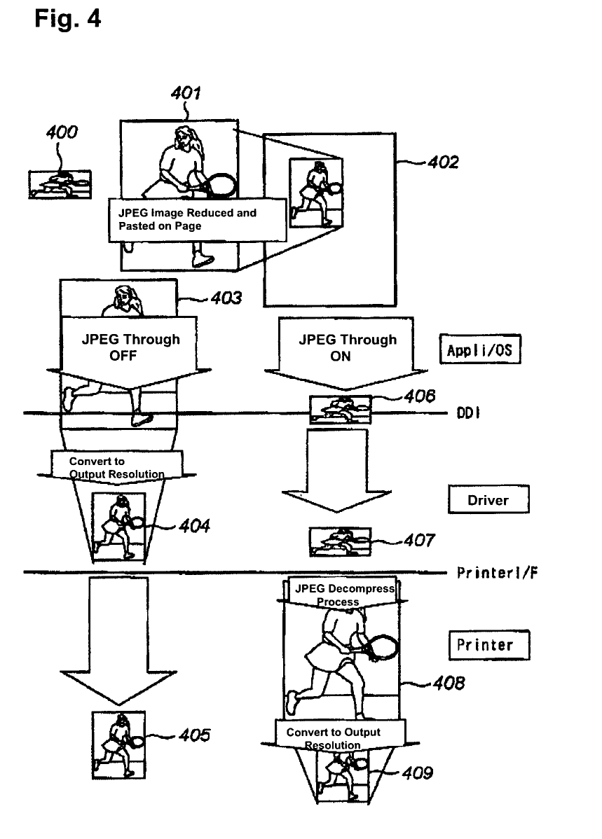

FIG. 5 schematically shows details of processing in accordance with an embodiment of the present invention.

FIG. 6 shows a flowchart of a sequence of operation processing in accordance with an embodiment of the present invention.

### DESCRIPTION OF THE PREFERRED EMBODIMENTS

Preferred embodiments according to the present invention will be described below.

A first embodiment of the present invention is described below in detail with reference to the accompanying drawings.

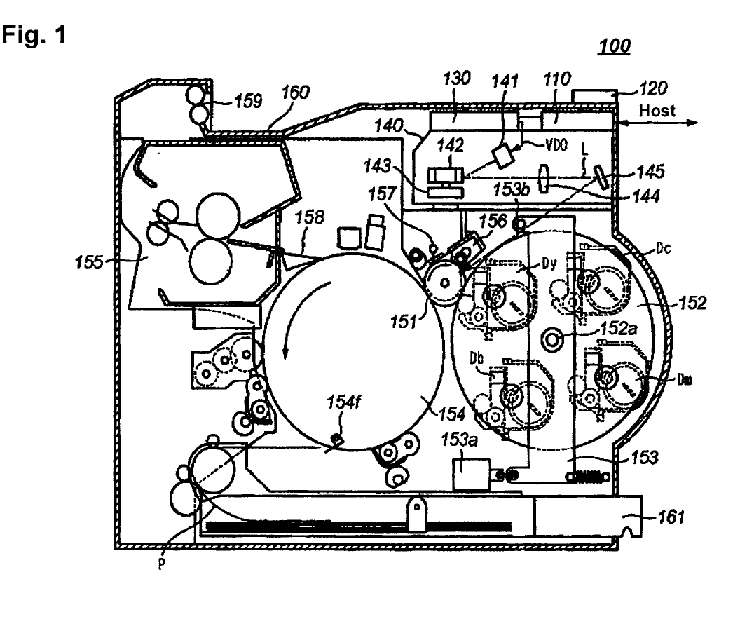

First, referring to FIG. 1, a description is made as to a structure of a color laser beam printer (hereinafter called the “color LBP”) 100, which handles printing in a printing system to which the present embodiment is applied.

FIG. 1 is a side cross-sectional view of the structure of the color LBP 100. The color LPB is capable of printing images with a resolution of 600 dots per inch (dpi), for example, and records images based on multi-value data, in which each pixel of each color component is expressed in 8 bits.

The color LBP 100 is a device that inputs and stores print information consisting of print data (e.g., character codes and image data) and control codes that are supplied from a host computer externally connected to the color LBP. The color LBP 100 creates character patterns and images corresponding to such print information and forms pictures on recording paper, which is a recording medium.

The color LBP 100 includes a formatter control section 110 that analyzes the print information supplied from the host computer and generates print image, as well as controlling the color LBP100. The formatter control section 110 is connected with an operation panel section 120, on which switches for user operation and LED displays for notifying status to the user are disposed. The panel section 120 may be mounted on the exterior of the color LBP 100 or provided as an integral exterior part of the color LBP 100. The final print image generated by the formatter control section 110 is sent to an output control section 130 as a video signal. The output control section 130 outputs control signals to an optical unit 140 and various drive mechanism sections together with status inputs from various sensors (not shown in drawings) provided in the color LBP 100, and governs the control of the print processing of the color LBP 100.

In the printer shown in FIG. 1, a sheet of a paper P that is fed from a paper feed cassette 161 has its end gripped by a gripper 154f, and is retained on the outer circumference of an image transfer drum 154. Latent images of multiple colors formed on a photosensitive drum 151 by the optical unit 140 is developed by color developers Dy, Dm, Dc and Db for yellow (Y), magenta (M), cyan (C) and black (B), respectively, and through transferring the developed images over several times, a multi-colored image is formed on the sheet of paper P, which is retained on the outer conference of the image transfer drum 154. Thereafter, the paper P is separated from the image transfer drum 154, the image on the paper P is fixed by a fixing unit 155, and is delivered to a paper delivery tray section 160 by a paper delivery section 159. Here, each of the developers Dy, Dm, Dc and Db for the multiple colors has pivots on either end, and each of the developers is held by a developer selection mechanism section 152 in a manner rotatable around its respective pivot. With this structure, each of the developers Dy, Dc, Db and Dm is structured so that its posture can be maintained in a constant position, as shown in FIG. 1, even when the developer selection mechanism section 152 rotates around a rotating shaft 152a to select a developer.

After the selected developer moves to a developing position, as a selection mechanism holding frame 153, with a fulcrum 153b as the center, is pulled towards the photosensitive drum 151 by a solenoid 153a, the developer selection mechanism section 152 and the selected developer move in a unitary fashion towards the photosensitive drum 151, so that the developing processing can take place.

Next, the photosensitive drum 151 becomes uniformly charged in a predetermined polarity by a charger 156. The print information that was developed as a device-dependent bitmap by the formatter control section 110 is converted to a video signal with a corresponding pattern, which is output to a laser driver and drives a semiconductor laser 141. The laser beam that is emitted by the semiconductor laser 141 in response to the video signal input is controlled to turn on and off The laser beam is oscillated side to side by a polygon mirror 142 that can rotate at high-speed by a scanner motor 143, such that it scans over and exposes the photosensitive drum 151 via a polygon lens 144 and a reflective mirror 145. Through this operation, an electrostatic latent image of an image pattern is formed on the photosensitive drum 151. Next, for example, an electrostatic latent image in M (magenta) color is developed by the M (magenta) color developer Dm, so that the first toner image in M (magenta) color is formed on the photosensitive drum 151. In the meantime, the sheet of transfer paper P is fed in a predetermined timing, and a transfer bias voltage having a polarity opposite to that of the toner (e.g., positive polarity) is applied to the transfer drum 154; the first toner image on the photosensitive drum 151 is transferred onto the sheet of transfer paper P and the sheet of transfer paper P is electrostatically adhered on the surface of the transfer drum 154.

Then, a cleaner 157 removes the residual M (magenta) color toner from the photosensitive drum 151, which is then prepared for the latent image formation and developing processes with the next color. Subsequently, toner image transfers for the second, third and fourth colors take place in the order of C (cyan), Y (yellow) and B (black) following the same procedure as described above. However, one difference is that the bias voltage that is applied to the transfer drum 154 becomes progressively higher each time a new color is transferred.

When the end section of the sheet of transfer paper P on which the toner image in four colors is superposed approaches a separating position, a separating claw 158 moves closer, and its tip comes into contact with the surface of the transfer drum 154 and separates the sheet of transfer paper P from the transfer drum 154. The sheet of transfer paper P separated is carried to the fixing unit 155, where the toner image on the sheet of transfer paper P is fixed and the sheet of transfer paper P is delivered onto the paper delivery tray 160. The color LBP according to the present embodiment outputs images having a 600 dpi resolution through the image formation process described above. Printers to which the present embodiment is applicable are not limited to the color LBP described above, and color printers using other printing methods, such as inkjet printers and thermal printers, may also be used.

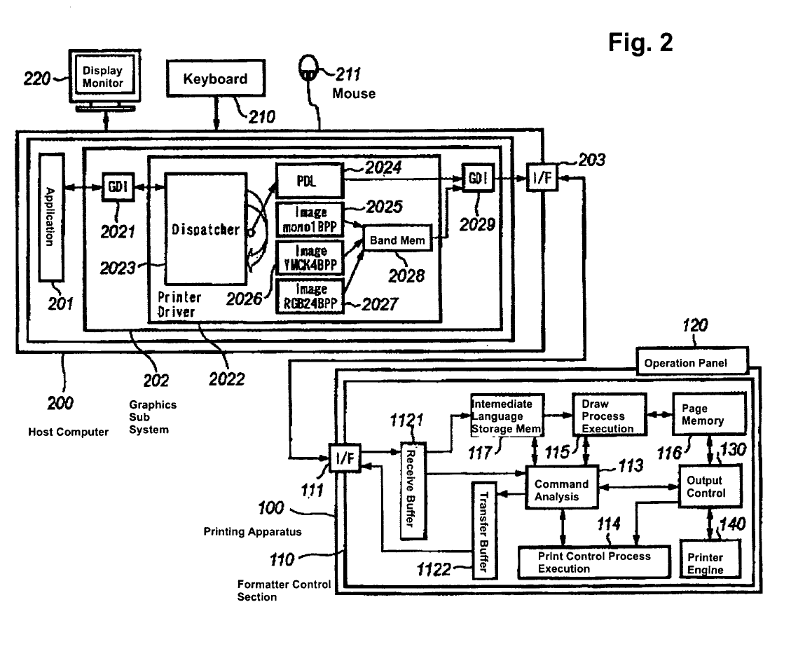

Next, a description is made as to the formatter control section 110 of the printer 100 using FIG. 2. The formatter control section 110 is a section also commonly called a PDL controller. The formatter control section 110 comprises an interface (I/F) section 111, which is a device to connect with a host computer, a receiving buffer 1121 that temporarily stores and manages received data, a transmission buffer 1122 that temporarily stores and manages transmission data, a command analysis section 113 that governs the analysis of print data, a print control processing execution section 114, a draw processing execution section (includes a JPEG decompression module) 115, and a page memory 116.

The interface (I/F) section 111 is a communication device for sending and receiving print data with a host computer 200 and enables communications that conform to the communication protocol IEEE-1284. However, the communication device is not limited to this system, and can be a connection through various protocols via a network or a communication device conforming to IEEE-1394, and any connection mode can be employed. The print data received through the interface section 111 is successively accumulated in the receiving buffer 1121, which is a storage device that temporarily holds the data, and the data is read and/or processed by the command analysis section 113 or the draw processing execution section 115 as necessary. The command analysis section 113 comprises various PDL command systems and/or control programs based on the print job control language; the analysis result of print data concerning drawing such as character printing, graphics and images is processed by giving instructions to the draw processing execution section 115, while commands other than for drawing, such as for paper feed selection and reset, are processed by giving instructions to the print control processing execution section 114.

The draw processing execution section 115 is a renderer that successively develops each drawing object such as characters and images onto the page memory 116. In the present embodiment, the decompression of JPEG-compressed image data also takes place here. A device-dependent bitmap data has to be sent to the color LBP in FIG. 1 in the order of M, C,Y and B planes. However, in normal states, not all of the memory that is required for this purpose is secured. Instead, a band region for a fraction of one plane (1, 2 or 4 bits/pixel) is secured as memory, and images are processed by repeatedly using this band region while synchronizing with the printer engine speed. Normally, the page memory 116 is managed through cycles of alternating development processing and sending video signals to the printer engine, in other words, a banding control, by the MCYB renderer, but when there is sufficient memory, a region that would allow the development of a full page may be secured. Generally, the formatter control section 110 is made up of a computer system that uses a central processing unit (CPU), a read only memory (ROM) and a random access memory (RAM). The processing by each section can be handled through time sharing processing under a multitasking monitor (a real-time operating system), or it can be handled by having a dedicated controller hardware for each function so that each function is independently processed.

An operation panel 120 sets and displays various statuses of the printer, as described earlier. An output control section 130 converts the content of the page memory 116 into a video signal and transfers an image to a printer engine section 140. The printer engine section 150 is a print mechanism section that forms a permanently visible image on a sheet of recording paper based on the video signal received; this element appeared in the description of FIG. 1.

The above concludes the description of the printer 100. Next, we will explain the entire structure of a printing system according to the present embodiment, including the host computer 200.

Referring to FIG. 2, the host computer (e.g., personal computer) 200, in addition to operating applications, also outputs to the printer 100 print information comprising print data and control codes required. The host computer 200 is a computer system comprising an input device 210 such as a keyboard, a pointing device such as a mouse 211, and a displaying device such as a display monitor 220. Here, the host computer 200 operates on a basic operating system such as Windows 95/98/Me/XP, but the operating system is naturally not limited to these.

On the host computer 200, major functional categories that run on the basic operating system and that relate to the functions concerning the present embodiment are an application software 201, a graphics subsystem 202, and an I/F 203 that processes communications with the printer.

The application software 201 refers to application software such as a word processor or a spreadsheet that runs on a basic software, and its type is irrelevant as long as it is an application that has a print function.

The graphics subsystem 202 comprises a graphic device interface (hereinafter called “GDI”) 2021, which is a part of the functions of the basic operating system, and a printer driver 2022, which is a device driver dynamically linked with the GDI 2021. A dispatcher 2023 is a module positioned at the entrance to the printer driver 2022 and switches and loads a PDL translator 2024 or one of the image mode translators 2025-2027, depending on the graphics mode selected by the user, in order to execute conversion processing or draw processing. Each of the image mode translators 2025-2027 performs draw processing by using a band memory 2028.

The result of a conversion or drawing is sent to a GDI 2029 as a print command, which then is sent to the printer 100 through the I/F 203.

The names and functional frameworks described above may somewhat vary depending on the basic operating system used, but such names and frameworks are not major issues in the present invention as long as the modules in question realize the various technical devices discussed in the present embodiment. For example, what is called a spooler or a spool file can be realized by assembling its processing into a module called print queue under a different operating system. In general, the host computer 200 that includes the various functional modules is set up so that a software called a basic software controls hardware, such as a CPU, a ROM, a RAM, a hard disk drive (HDD) and various input/output control sections (I/O); and various application software and subsystem processes operate as functional modules on the basic software.

In accordance with the present embodiment, the manners of processing JPEG-compressed image data are switched one from the other in the PDL translator 2024, so that the maximum throughput can be obtained for the JPEG-compressed image data.

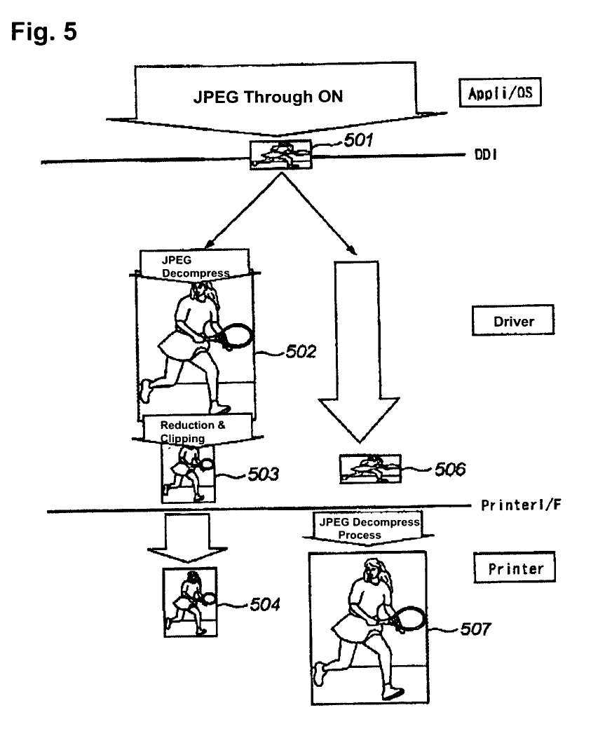

A summary of the operation of the present embodiment is described with reference to a schematic in FIG. 5.

In the present embodiment, the printer always declares to the operating system that it “can receive JPEG image data.” The processing system that takes place within the printer driver for an image data 501 that has been JPEG-compressed is switched as follows, depending on such conditions as the image data size at image development, designation of enlargement/reduction (i.e., zooming), the size of the clipping region:

When decompression processing takes place: A decompression processing takes place using an decompression module within the printer driver (502). Zooming and clip processing are rendered on the decompressed image, a print command is generated (503), and the image and command are sent to the printer.

When no decompression takes place: The printer driver attaches a print command to the compressed data and sends them to the printer.

Next, we will describe a determination routine that switches the processing systems, which takes place within the printer driver.

In the present embodiment, the processing speed of each of the processing systems described above is estimated and a decision is made as to which is optimum. To this end, the parameters for printing are determined in the following manner:

Image converting time=zooming processing time, clipping processing time

<When Decompression Takes Place>

Data size when decompressed=drawing region (i.e., region after zooming and outer most rectangle of clipping region)

Processing time estimate=processing time within the host computer (JPEG decompression time+image conversion time)

+transfer time (data size when decompressed×compression rate×transfer rate)

+processing time within the printer (data size when decompressed×image processing speed within the printer)

<When no Decompression Takes Place>

Processing time estimate=transfer time (JPEG image size×transfer rate)

+processing time within the printer (JPEG decompression time+image converting time)

By storing in the printer driver the printer processing speed of the printer connected and obtaining the CPU speed information of the host computer, the JPEG decompression time and the image converting time can be found. To find the processing speed of the printer connected, a table that stores data regarding processing speeds of a plurality of types of printers can be prepared in advance; the appropriate processing speed can then be found from the table by finding through some means the model of the printer (including model name or model number) that is actually connected. In terms of the method to find the printer model, one way is to have a list of printer models displayed as a setting for the printer driver and have the user select one from the list (consequently, the selection process takes place only once and the setting preferably should be done during installation); if there is a two-way communication between the printer and the host computer, a command to inquire the model name and/or status can be issued to the printer and a determination can be made based on the response. The processing speed of the host computer can be found by checking the processor used and/or a clock, which are publicly known information.

A standard value can be applied for the transfer rate between the host computer and the printer by obtaining the connection port name from the printer driver. However, another realizable embodiment that is naturally conceivable is to improve the accuracy of the estimates by using a mechanism to obtain parameter values in advance from a test print.

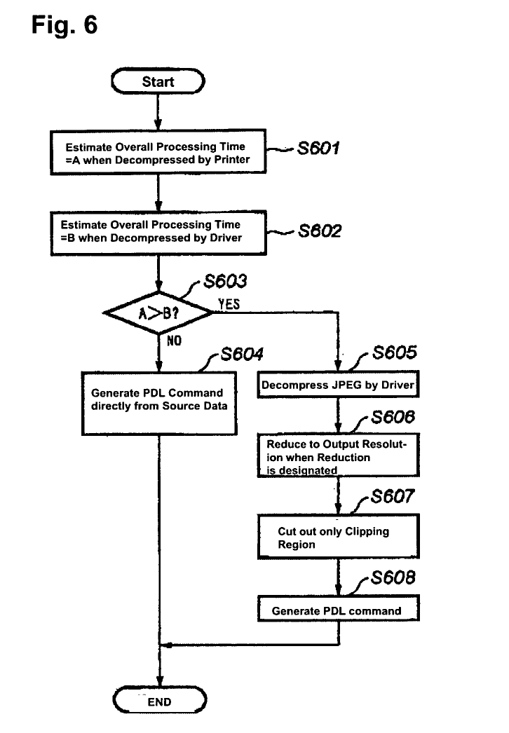

A flowchart in FIG. 6 shows the procedure for processing a JPEG-compressed image data that takes place within the printer driver according to the present embodiment.

In step S601, an overall processing time=A is estimated. This is applicable to a case when a JPEG-compressed image data that was sent from a host processing (e.g., an application or an operating system) is sent to the printer without any alterations, and the printer decompresses the image data. The overall processing time A is estimated based on image processing such as decompression, enlargement or reduction processing (which are collectively called “zooming”), and clipping processing.

Next, in step S602, an overall processing time=B of the printer is estimated, and this is applicable when a print command is sent to the printer as a result of the printer driver performing image processing, such as decompression, zooming, and clipping processing, on a JPEG-compressed image data, and the printer receives the command.

In step S603, a determination is made as to whether or not the result of operating (estimating) through the above processes is A>B.

In this determination, when it is determined that A>B, the process proceeds to the next step S605, and when it is determined that A≦B, the next step is step S604.

In step S604, the JPEG-compressed image itself is treated as a print command and sent to the printer. The print command generated includes parameters required for processing that takes place in the printer.

On the other hand, when the process proceeds to step S605, a JPEG decompression processing is performed within the printer driver; a reduction or enlargement processing designated is performed in step S606; the image data is clipped in the outer most clipping region in step S607; and a PDL command is generated in step S608.

Since the printer according to the present embodiment has functions to internally process JPEG data, the printer can process the data from either step S604 or step S608.

As explained above, by switching the data format output to the printer adaptively, instead of indiscriminately outputting JPEG-compressed images to the printer, a high-speed printing becomes consistently possible when printing JPEG-compressed images, according to the present embodiment.

For example, when there are host computers A and B with different processing speeds and two systems in which the same printer is connected to both of the host computers, and when identical JPEG images are to undergo a print processing with identical editing using identical operating systems and identical applications, due to the fact that the throughput is optimized, it is possible for one of the system to undergo the processing in step S604, while the other undergoes the processing that begins with step S605. In other words, in accordance with the present embodiment, in various systems comprising a host computer and a printer, a printing environment that is optimum for that system can be provided. The same applies when printers having the same functions but different processing capacities are each connected to each of the host computers having the same processing speed.

The present invention can be applied as a part of a system comprising a plurality of equipment (e.g., a host computer, an interface equipment, a reader, and a printer) or as a part of a device comprising a single equipment (e.g., a copier or a facsimile machine).

Furthermore, the present invention is not limited in terms of devices or methods that are used to realize the embodiment described above. For example, the embodiment described above may be realized through providing program codes for software (e.g., printer driver) and having a computer under the system or equipment described above operate the various devices according to the program codes. Such a system is also included as part of the present invention.

In this case, the program codes of the software themselves realize the functions of the embodiment. Consequently, the program codes themselves and the means to provide the program codes to a computer, specifically a memory medium that stores the program codes, are also included as part of the present invention.

Memory media to store such program codes include, for example, floppy disks, hard disks, optical disks, magneto-optical disks, CD-ROMs, DVDs, magnetic tapes, non-volatile memory cards, and ROMs.

In addition, program codes are also included as part of the present invention not only when the functions of the embodiment are realized by having a computer control the various devices according to only the program codes provided, but also when the embodiment is realized by having the program codes work jointly with an operating system or other application software running on the computer.

Furthermore, the following situation is also included as part of the present invention. Once the program codes provided are stored in a memory equipped on an expansion board of a computer or a memory on an expansion unit connected to a computer, a CPU equipped on the expansion board or the expansion unit performs a part or all of the actual processing based on the instructions from the program codes, and the present invention is realized through such processing.

As explained above, according to the present invention printing can be carried out with an optimal throughput when a compressed image data retained in a host computer is transferred to and printed by a printer.

What is claimed is:

1. An information processing apparatus that is connected to a printer that is capable of printing an image represented by image data whether the image data is in compressed format or non-compressed format, the information processing apparatus comprising:
a first print command generation device that generates a print command while compressed image data remains compressed;
a second print command generation device that generates a print command when compressed image data is decompressed;
an estimation device that estimates a processing time required for a printing process that uses the first print command generation device and a processing time required for a printing process that uses the second print command generation device when the image data for an image to be printed is compressed image data; and
a selection device that selects one of the first print command generation device and the second print command generation device depending on an estimation result,
wherein a print command is generated by the selected one of the first print command generation device and the second print command generation device to conduct a printing process for the compressed image data.

2. An information processing apparatus according to claim 1, wherein each of the processing times is calculated based on at least one of a data transfer rate of a connection interface between the information processing apparatus and the printer, a processing capability of the printer, and processing capability of the information processing apparatus.

3. An information processing apparatus according to claim 2, wherein the estimation device estimates a print processing time using the first print command generation device based on a data transfer time determined by a data transfer rate of a connection interface between the information processing apparatus and the printer and a size of the compressed image data, and a time required for processing the compressed image data using a processing capability of the printer.

4. An information processing apparatus according to claim 2, wherein the estimation device estimates a print processing time using the second print command generation device based on a time required for decompressing the compressed image data and performing a specified image conversion processing using a processing capability of the information processing apparatus and a data transfer time determined by a data transfer rate of a connection interface between the information processing apparatus and the printer and a size of an image data after the image conversion processing.

5. An information processing apparatus according to claim 2, wherein the estimation device estimates a print processing time using the first print command generation device based on a data transfer time determined by a data transfer rate of a connection interface between the information processing apparatus and the printer and a size of the compressed image data, and a time required for processing the compressed image data using a processing capability of the printer, and estimates a print processing time using the second print command generation device based on a time required for decompressing the compressed image data and performing a specified image conversion processing using a processing capability of the information processing apparatus and a data transfer time determined by a data transfer rate of a connection interface between the information processing apparatus and the printer and a size of an image data after the image conversion processing.

6. An information processing apparatus according to claim 1, wherein the compressed image data is an image data that is compressed by JPEG system.

7. A printing system comprising a printer that is capable of printing an image represented by image data whether the image data is in compressed format or non-compressed format and an information processing apparatus that is connected to the printer, wherein the information processing apparatus comprises:
a first print command generation device that generates a print command while compressed image data remains compressed;
a second print command generation device that generates a print command when compressed image data is decompressed;
an estimation device that estimates a processing time required for a printing process that uses the first print command generation device and a processing time required for a printing process that uses the second print command generation device when the image data for an image to be printed is compressed image data; and
a selection device that selects one of the first print command generation device and the second print command generation device depending on an estimation result,
wherein a printing process for the compressed image data is conducted with a print command that is generated by the selected one of the first print command generation device and the second print command generation device.

8. An information processing apparatus according to claim 7, wherein each of the processing times is calculated based on at least one of a data transfer rate of a connection interface between the information processing apparatus and the printer, a processing capability of the printer, and processing capability of the information processing apparatus.

9. An information processing apparatus according to claim 8, wherein the estimation device estimates a print processing time using the first print command generation device based on a data transfer time determined by a data transfer rate of a connection interface between the information processing apparatus and the printer and a size of the compressed image data, and a time required for processing the compressed image data using a processing capability of the printer.

10. An information processing apparatus according to claim 8, wherein the estimation device estimates a print processing time using the second print command generation device based on a time required for decompressing the compressed image data and performing a specified image conversion processing using a processing capability of the information processing apparatus and a data transfer time determined by a data transfer rate of a connection interface between the information processing apparatus and the printer and a size of an image data after the image conversion processing.

11. An information processing apparatus according to claim 8, wherein the estimation device estimates a print processing time using the first print command generation device based on a data transfer time determined by a data transfer rate of a connection interface between the information processing apparatus and the printer and a size of the compressed image data, and a time required for processing the compressed image data using a processing capability of the printer, and estimates a print processing time using the second print command generation device based on a time required for decompressing the compressed image data and performing a specified image conversion processing using a processing capability of the information processing apparatus and a data transfer time determined by a data transfer rate of a connection interface between the information processing apparatus and the printer and a size of an image data after the image conversion processing.

12. An information processing apparatus according to claim 7, wherein the compressed image data is an image data that is compressed by JPEG system.

13. A method of controlling an information processing apparatus that is connected to a printer that is capable of printing an image represented by image data whether the image data is in compressed format or non-compressed format, the method comprising:
a first print command generation step of generating a print command while compressed image data remains compressed;
a second print command generation step of generating a print command when compressed image data is decompressed;
an estimation step of estimating a processing time required for a printing process that uses the first print command generation device and a processing time required for a printing process that uses the second print command generation device when the image data for an image to be printed is compressed image data; and
a selection step of selecting one of the first print command generation device and the second print command generation device depending on an estimation result,
wherein a printing process for the compressed image data is conducted with a print command that is generated by the selected one of the first print command generation device and the second print command generation device.

14. A method of controlling an information processing apparatus according to claim 13, wherein each of the processing times is calculated based on at least one of a data transfer rate of a connection interface between the information processing apparatus and the printer, a processing capability of the printer, and processing capability of the information processing apparatus.

15. A method of controlling an information processing apparatus according to claim 14, wherein the estimation step estimates a print processing time using the first print command generation device based on a data transfer time determined by a data transfer rate of a connection interface between the information processing apparatus and the printer and a size of the compressed image data, and a time required for processing the compressed image data using a processing capability of the printer.

16. A method of controlling an information processing apparatus according to claim 14, wherein the estimation step estimates a print processing time using the second print command generation device based on a time required for decompressing the compressed image data and performing a specified image conversion processing using a processing capability of the information processing apparatus and a data transfer time determined by a data transfer rate of a connection interface between the information processing apparatus and the printer and a size of an image data after the image conversion processing.

17. A method of controlling an information processing apparatus according to claim 14, wherein the estimation step estimates a print processing time using the first print command generation device based on a data transfer time determined by a data transfer rate of a connection interface between the information processing apparatus and the printer and a size of the compressed image data, and a time required for processing the compressed image data using a processing capability of the printer, and estimates a print processing time using the second print command generation device based on a time required for decompressing the compressed image data and performing a specified image conversion processing using a processing capability of the information processing apparatus and a data transfer time determined by a data transfer rate of a connection interface between the information processing apparatus and the printer and a size of an image data after the image conversion processing.

18. A method for controlling an information processing apparatus that is connected to a printer that is capable of printing an image represented by image data whether the image data is in compressed format or non-compressed format, the method comprising the steps of:
estimating a processing time required for a printing process in which a non-compressed print image is generated from a compressed image data at the information processing apparatus side, and a processing time required for a process in which a non-compressed print image is generated from a compressed image data at the printer side; and
conducting a printing process for the compressed image data at one of the information processing apparatus side and the printer side depending on the estimated processing times.

19. A computer program for controlling an information processing apparatus that is connected to a printer that is capable of printing an image represented by image data whether the image data is in compressed format or non-compressed format, the computer program comprising:
a first print command generation step of generating a print command while compressed image data remains compressed;
a second print command generation step of generating a print command when compressed image data is decompressed;
an estimation step of estimating a processing time required for a printing process that uses the first print command generation device and a processing time required for a printing process that uses the second print command generation device when the image data for an image to be printed is compressed image data; and
a selection step of selecting one of the first print command generation device and the second print command generation device depending on an estimation result,
wherein a printing process for the compressed image data is conducted with a print command that is generated by the selected one of the first print command generation device and the second print command generation device.

20. A computer program for controlling an information processing apparatus according to claim 19, wherein each of the processing times is calculated based on at least one of a data transfer rate of a connection interface between the information processing apparatus and the printer, a processing capability of the printer, and processing capability of the information processing apparatus.

21. A computer program for controlling an information processing apparatus according to claim 19, wherein the estimation step estimates a print processing time using the first print command generation device based on a data transfer time determined by a data transfer rate of a connection interface between the information processing apparatus and the printer and a size of the compressed image data, and a time required for processing the compressed image data using a processing capability of the printer, and estimates a print processing time using the second print command generation device based on a time required for decompressing the compressed image data and performing a specified image conversion processing using a processing capability of the information processing apparatus and a data transfer time determined by a data transfer rate of a connection interface between the information processing apparatus and the printer and a size of an image data after the image conversion processing.

22. A storage medium that stores the computer program set forth in claim 19.
